(19) United States
(12) Patent Application Publication
(10) Pub. No.: US 2014/0034556 A1
(43) Pub. Date: Feb. 6, 2014

(54) APPARATUS AND METHOD FOR PARTICLE SEPARATION

(71) Applicants: Hongshen Ma, Delta (CA); Thomas Gerhardt, Constantia (ZA); William James Beattie, Toronto (CA)

(72) Inventors: Hongshen Ma, Delta (CA); Thomas Gerhardt, Constantia (ZA); William James Beattie, Toronto (CA)

(73) Assignee: THE UNIVERSITY OF BRITISH COLUMBIA, Vancouver (CA)

(21) Appl. No.: 13/980,549

(22) PCT Filed: Jan. 19, 2012
(86) PCT No.: PCT/CA2012/000066

§ 371 Date: Sep. 10, 2013

Related U.S. Application Data
(60) Provisional application No. 61/434,344, filed on Jan. 19, 2011.

(51) Int. Cl. B03B 5/00

(52) U.S. Cl. CPC B03B 5/00
USPC 209/684; 137/10; 209/659

(57) ABSTRACT

An particle separation microstructure comprising a body and a flow channel extending through the body, having an inlet and an outlet for receiving a flow of particles therethrough. The flow channel comprises opposing first and second walls disposed in a spaced-apart relationship and at least one protrusion extending from the first wall into the flow channel and extending along a length of the flow channel. At least a portion of one of the first and second walls is reversibly actuatable between a first and a second position and the first and second walls are substantially parallel in the second position. In the first position the flow channel is open for receiving the flow of particles and in the second position the at least one protrusion abuts the second wall and the flow channel is constricted for restricting the flow of particles and separating particles from the flow of particles.

### CROSS REFERENCE TO RELATED APPLICATIONS

This application claims the benefit of priority of U.S. Provisional Patent Application No. 61/434,344 filed Jan. 19, 2011 which is incorporated herein by reference in its entirety.

### FIELD

The present disclosure relates generally to methods and apparatus for particle separation. More particularly, the present disclosure relates to methods and apparatus that separate a heterogeneous mixture of particles, using one or more physical characteristics of the particles.

### BACKGROUND

The separation of cells based on their physical differences is important in many areas of medical research and clinical practice. Previous technologies for physical separation include hydrodynamic chromatography, which separate cells based on size alone, and filtration, which separate cells based on size and rigidity. Separation based on size and rigidity is generally considered to be more useful since size alone is often insufficient to distinguish different cell types. (Hochmuth R M (2000) Journal of Biomechanics 33(1):15-22; Jones W R, et al. (1999) Journal of Biomechanics 32(2):119-127; Rosenbluth M J, et al (2006) Biophysical Journal 90(8):2994-3003)

The filtration of cells generally involves the use of microstructures that trap cells with greater size and/or rigidity, while eluting the cells with smaller size and/or rigidity. (VanDelinder et al., 2007 Analytical Chemistry 79(5):2023-2030; Vona G, et al. 2000 American Journal of Pathology 156(1):57-63 Murthy S et al. 2006 Biomedical Microdevices 8(3):231-237; Mohamed H et al., 2009 Journal of Chromatography A 1216(47):8289-8295; Tan S et al., 2009 Biomedical Microdevices 11(4):883-892) A recurring limitation in the filtration of cells is clogging, or the build up of particles within the filter microstructure. Clogging alters the hydrodynamic resistance of the filter, causing loss of specificity, yield, and throughput. Additionally, constant contact between the cell membrane and the filter wall can increase the incidence of cells adsorbing on to the filter wall and, in turn, prevent the recovery of cells after separation.

U.S. Patent Application 2008/0264863 discloses microfluidic sieve valve having a flexible membrane, deformable under a certain pressure to create a sieve where certain particles are trapped while the suspending fluid is allowed to flow.

It is, therefore, desirable to provide an improved apparatus and method for particle separation.

### SUMMARY

It is an object of the present disclosure to obviate or mitigate at least one disadvantage of prior art.

The Applicant recognized that providing a flow channel capable of moving between and an open and a semi-closed or constricted configuration, and selectively controlling the flow though the flow channel enables the selective separation of specific particle types from a flow of particles.

There is described herein a particle separation microstructure, an apparatus for particle separation, and a method for particle separation. The particle separation microstructure comprises a body, and a flow channel extending through the body having an inlet and an outlet for receiving a flow of particles therethrough. The flow channel comprises a pair of opposing first and second walls disposed in a spaced-apart relationship and at least one protrusion extending from the first wall into the flow channel, the protrusion extending along a length of the flow channel. At least a portion of one of the first and second wall is reversibly actuatable between a first and a second position and the first and second walls are substantially parallel in the second position. in the first position the flow channel is open for receiving the flow of particles, and in the second position the at least one protrusion abuts the second wall and the flow channel is constricted for separating particles from the flow of particles.

In a further embodiment, there is provided a control channel extending through the body for receiving a pressurizable fluid. The control channel comprises at least a portion of the actuatable first or second wall of the flow channel, and a third wall disposed in an opposing spaced-apart relationship. The control channel applies pressure to the portion of the actuatable first or second wall when the flow channel is in the second position.

In further aspect, the present disclosure provides an apparatus for particle separation. The apparatus comprises particle separation microstructure described above, sample and buffer conduits connected to the flow channel inlet, first and second particle conduits connected to the flow channel outlet, and flow control valves. Flow control valves are disposed between each of the sample and buffer conduits and the flow channel inlet for modulating the flow of particles and a flow of buffer received by the flow channel. Flow control valves are disposed between the outlet of the flow channel and each of first and second particle conduits for discharging separated particles from the flow of particles. The opening and closing of the flow control valves corresponds with the actuation of the flow channel between the first and second positions to separate particles from the flow of particles.

In a further embodiment, there is provided a method for particle separation comprising providing a flow of particles to a microstructure comprising a flow channel, the flow channel having a pair of reversibly actuatable opposing inner channel surfaces; modulating at least a portion of the flow channel inner surfaces between a first and a second position, where the pair of opposing inner flow channel surfaces are substantially parallel in the second position; and separating particles from the flow of particles, wherein movement of the separated particles is impeded when the flow channel is constricted in the second position, and the flow of particles passes through the flow channel when the flow channel constricted and when the flow channel is open in the first position.

In a further aspect, the disclosure relates to a method for selectively attenuating the velocities of specific particle types comprising providing a flow of particles to a microstructure comprising a flow channel, the flow channel having a pair of reversibly actuatable opposing inner channel surfaces; modulating at least a portion of the flow channel inner surfaces between a first position where the flow channel is open, and a second position where the flow channel is restricted, where the pair of opposing inner flow channel surfaces are substantially parallel in the second position, and where the flow of a first population of particles is impeded when flow channel is in the restricted position; and attenuating the velocity of the first and second population of particles, wherein the first population of particles travels at a slower speed than a second population of particles that passes through the flow channel in the restricted position, and wherein repeated movement of the pair of opposing flow channel surfaces between the first and second positions, concentrates the first population of particles relative to the second population of particles as the flow of particles passes through the flow channel.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures in which like reference numerals refer to like elements.

FIG. 1A is a cross sectional view of an embodiment of the particle separation apparatus in an open position;

FIG. 1B is a cross sectional view of the particle separation apparatus of FIG. 1A in a reduced flow position;

FIG. 2A is a cross sectional view of an embodiment of a particle separation apparatus in an open position;

FIG. 2B is a cross sectional view along the x-axis of the plane defined by z and y axis of the particle separation apparatus of FIG. 2A;

FIG. 3A is a cross sectional view the particle separation apparatus of FIG. 2A in a reduced flow position;

FIG. 3B is a cross sectional view along the x-axis of the plane defined by z and y axis of the particle separation apparatus of FIG. 3A;

FIG. 4 a top sectional view along the z axis of the particle separation apparatus of FIG. 2A;

FIG. 5 is a top sectional of an embodiment of a particle separation apparatus ;

FIG. 6 is a graphical illustration of the application of pressure on an embodiment of a particle separation apparatus which shows the correlation of relative pressure applied to trapped particle size;

FIG. 7 is a cross sectional view of an embodiment of the particle separation apparatus where a portion of the apparatus is in an open position and a portion of the apparatus is in a reduced flow position;

FIG. 8(A)-(C) illustrates a particle separation apparatus comprising an embodiment of a microstructure and a method of separating various sized particles from a mixture of particles using the particle separation apparatus;

FIG. 9 illustrates a plurality of particle separation apparatus implemented in serial for a multi-stage selection of the target particles;

FIG. 10 is a graphical illustration showing the displacement of a red blood cell, a mouse lymphoma cell, and a peripheral blood mononuclear cell in a flow through an embodiment of a particle separation apparatus under a 50% duty cycle;

FIG. 11A is a series of images from a video of a peripheral blood mononuclear cell traversing an embodiment of the particle separation apparatus wherein the flow channel of the apparatus is moved from the open to semi-closed position at t=10.5 s;

FIG. 11B is a series of images from a video of a mouse lymphoma cell traversing an embodiment of the particle separation apparatus wherein the flow channel of the apparatus is moved from the open to semi-closed position at t=10.5 s; and

FIG. 12 is a graphical illustration showing the average forward velocity of different cell types in a flow through an embodiment of a particle separation apparatus under different duty cycles.

### DETAILED DESCRIPTION

Generally, the present disclosure provides, in part, a novel method, microstructure and apparatus for particle separation. More particularly, methods, microstructure and apparatus for separation of particles based on physical characteristics such as size, rigidity, or size and rigidity. An apparatus for particle separation comprising at least one particle separation microstructure is also described. Methods of particle separation, selectively attenuating the velocity of particles, and treating or preventing clogging of a particle separation apparatus are also provided.

Microfluidic devices for the physical separation of particles are well known in the art and include for example, size-exclusion chromatography devices, which separate particles based on size alone, and filtration devices, which separate particles based on size and rigidity. Size-exclusion chromatography is typically not effective for separating particles, where the particles are cells because the desired cell fractions, phenotypes, or morphologies often cannot be distinguished based on size alone.

The Applicant has recognized the re-occurring problem associated with filtration devices where particles, for example cells, clog the filter. The clogging cells slow the infusion rate of the incoming flow sample and alter the hydrodynamic resistance of the filter unpredictably. The Applicant has further recognized the unsuitability of size-exclusion chromatography for the separation of cells because of the lack of column materials or structures that can impart sufficiently distinct flow velocities to different cell phenotypes to enable efficient separation. In turn, the Applicant has recognized that the persistent, non-moving contact that occurs using traditional filtration apparatus increases the incidence of particles, for example cells, adsorbing on to a filter wall, which not only clogs the filter, but prevents the recovery of particles after separation.

The Applicant has recognized a need to periodically remove trapped particles from a filter microstructure in order to reset the properties of the filter to improve specificity, yield, and throughput. Specifically, the Applicant has recognized a need alter a filter microstructure during the filtration process to facilitate the release of the trapped particles. Furthermore, the Applicant has recognized the need to provide a microstructure capable of precisely controlling a flow of particles and minute volumes of liquid, and separate particles based on their physical properties, more specifically, size and deformability.

The Applicant has recognized that providing a flow channel capable of moving between and an open and a semi-closed or constricted configuration, and selectively controlling the flow though the flow channel enables the selective separation of specific particle types from the flow of particles comprising a mixture of different particle types.

The Applicant has also surprisingly discovered that dynamically altering the geometry of a flow channel between an open and a semi-closed or constricted configuration such that the opposing longitudinal inner surfaces of the flow channel are substantially parallel in the semi-closed position, as the flow channel receives a flow of particles therethrough, facilitates the periodic entrapment of the larger, less deformable particles, thus facilitating particle separation on the basis of size and deformability. The height of the flow channel is altered in each of the open and a semi-closed positions.

Furthermore, the Applicant has discovered that dynamically altering the geometry of a flow channel between an open and a semi-closed or constricted configuration such that the opposing longitudinal inner surfaces of the flow channel are substantially parallel in the semi-closed position as the flow channel receives a flow of particles therethrough, imparts different flow rates to different particle types within the flow based on the distinct physical properties of the particles. Such a flow channel configuration provides a novel particle separation apparatus that enables particle separation via size-exclusion to separate cells based on their physical properties.

It is to be understood that particle rigidity, or deformability, refers to a particle's ability to resist deformation, which can be measured using a variety of known techniques including micropipette aspiration, atomic force microscopy, and optical tweezers.

In some embodiments, a particle separation microstructure according to the present disclosure comprises a body; and a flow channel extending through the body having an inlet and an outlet for receiving a flow of particles therethrough. The flow channel comprises opposing first and second walls disposed in a spaced-apart relationship. At least one protrusion extends from the first wall into the flow channel and extends along a length of the flow channel. A portion of one of the first or second wall is reversibly actuatable between a first and a second position, and the first and second walls are substantially parallel in the second position. In the first position, the flow channel is open for receiving the flow of particles. In the second position, the protrusion abuts the second wall and the flow channel is constricted for separating particles from the flow of particles.

The reversibly actuatable wall may comprise a flexible material. In one embodiment, the reversibly actuatable wall may be a flexible membrane actuated by the application of pressure.

The microstructure may further comprise a control channel extending through the body having an opening for receiving a pressurizable fluid. The control channel comprises at least a portion of the actuatable first or second wall and a third wall disposed in an opposing spaced-apart relationship. The control channel applies pressure to the portion of the actuatable first or second wall when the flow channel is in the second position.

The microstructure may comprise a plurality of control channels, where each of the plurality of control channels independently modulate a portion of the flow channel between the open and constricted positions. Each of the plurality of control channels may sequentially modulate the portion of the flow channel between the open and second constricted. In some embodiments, a portion of one of the first and second walls is reversibly actuatable in response to a signal.

The microstructure may comprise a plurality of flow channels extending through the body, where the flow channels are adjacent to one another, such that the flow channels are in parallel.

The flow channel of the microstructure may comprise at least one recess formed in one of the first and second walls for separating particles from the flow of particles when the flow channel is in the second position. In some embodiments, the microstructure may comprise at least two ribs transversely disposed and extending from the at least one protrusion into the flow channel to form the recess within the flow channel. The angle of the at least two ribs may be between about 30° to about 90° relative to a longitudinal axis of the flow channel.

In some embodiments, one protrusion extends substantially along the centerline of the flow channel. In some embodiments, one protrusion extends substantially along the centerline of the flow channel and one protrusion extends substantially along each edge of the flow channel.

In some embodiments, the particles are suspended in a fluid. The particles may be beads, cells, minerals, particulate, microorganisms or combinations thereof. In some embodiments, the cells are eukaryotic cells. At least one of the particles within the flow of particles may be labelled.

In some embodiments, an apparatus for particle separation according to the present disclosure comprises the microstructure previously described above; a sample conduit and a buffer conduit, connected to the flow channel inlet; a first particle conduit and a second particle conduit, connected to the flow channel outlet; and flow control valves. The flow control valves are disposed between each of the sample and buffer conduits and the flow channel inlet for modulating the flow of particles and a flow of buffer received by the flow channel, and disposed between the outlet of the flow channel and each of first and second particle conduits for discharging separated particles from the flow of particles. Opening and closing of the flow control valves corresponds with actuation of the flow channel between the first and second positions to separate particles from the flow of particles.

In some embodiments, a plurality of particle separation apparatus are connected in series for serial purification of the separated particles from the flow of particles.

The present disclosure further provides a method for particle separation comprising providing a flow of particles to a microstructure comprising a flow channel, the flow channel having a pair of reversibly actuatable opposing inner channel surfaces; modulating at least a portion of the flow channel inner surfaces between a first and a second position, where the pair of opposing inner flow channel surfaces are substantially parallel in the second position, separating particles from the flow of particles, wherein movement of the separated particles is impeded when the flow channel is constricted in the second position, and the flow of particles passes through the flow channel when the flow channel constricted and when the flow channel is open in the first position. The method may further comprise providing the flow channel with a plurality of flow control valves for modulating the flow of particles through the flow channel, wherein opening and closing of the flow control valves corresponds with actuation of the flow channel between the first and second positions to separate particles from the flow of particles. The method may further comprise providing a flow of buffer, when one of the flow control valves retains the flow of particles at a flow channel inlet for removing particles from the flow channel.

The present disclosure further provides a method for selectively attenuating the velocities of specific particle types comprising providing a flow of particles to a microstructure comprising a flow channel, the flow channel having a pair of reversibly actuatable opposing inner channel surfaces; modulating at least a portion of the flow channel inner surfaces between a first position where the flow channel is open, and a second position where the flow channel is restricted, where the pair of opposing inner flow channel surfaces are substantially parallel in the second position, and where the flow of a first population of particles is impeded when flow channel is in the restricted position; and attenuating the velocity of the first and second population of particles, wherein the first population of particles travels at a slower speed than a second population of particles that passes through the flow channel in the restricted position, and wherein repeated movement of the pair of opposing flow channel surfaces between the first and second positions, concentrates the first population of particles relative to the second population of particles as the flow of particles passes through the flow channel. The method may further comprise modulating a plurality of flow channel portions, wherein each of the flow channel portions moves independently between the first and second positions and the total volume of the flow channel is constant.

Particle Separation Microstructure

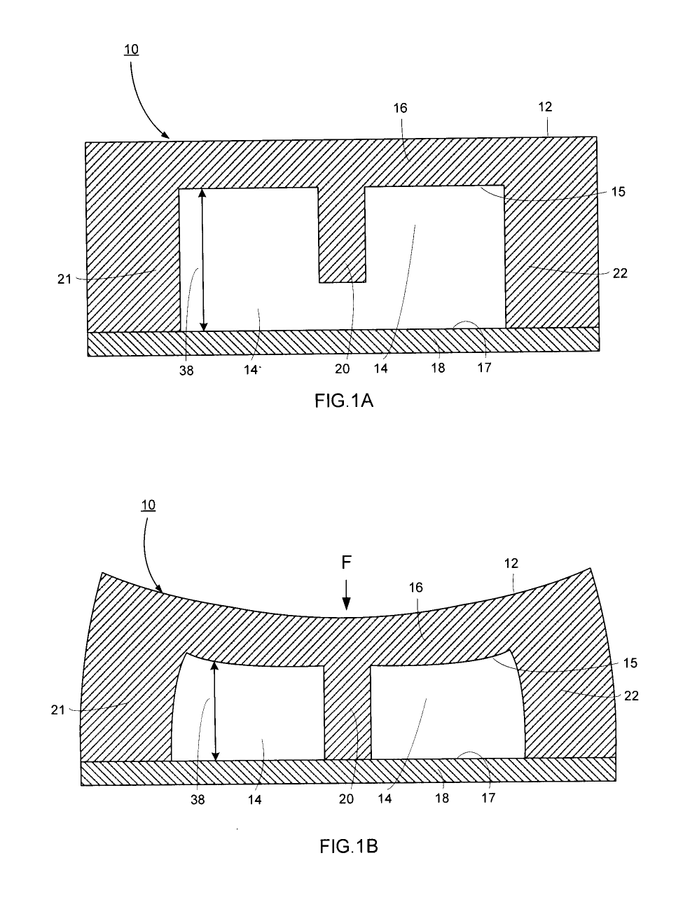

FIG. 1A and 1B show a particle separation microstructure 10 according to one embodiment in an open position and a constricted, reduced flow position respectively. The microstructure 10 facilitates the selective separation of a suspension of particles of different types. The microstructure 10 comprises a body 12 having a flow channel 14 extending through the body 12. The flow channel 14 is defined by a pair of first and second opposing walls (16, 18) and a pair of opposing side walls (21, 22), an inlet and an outlet for receiving a flow of particles therethrough. The first surface 15 of the first wall 16 and the second surface 17 of the second wall 18 are disposed in a spaced apart relationship, the first wall 16 having at least one protrusion 20 extending from the first surface 15 into the flow channel 14 and extending along a length of the flow channel 14. Preferably, at least one protrusion 20 is located substantially along a central longitudinal axis, the centerline, of the flow channel 14 as illustrated in FIG. 1. One of the first or second walls (16, 18) is reversibly actuatable, moving between a first position as shown in FIG. 1A and a second position as shown in FIG. 1B. FIG. 1 illustrates an embodiment where the first wall 16 is the reversibly actuatable wall. In the first position, the flow channel 14 is open for receiving a free flow of particles. In the second position, one of the first or second walls (16, 18) is deflected into the flow channel 14 and the protrusion 20 comes into contact with the second surface 17 of the second wall 18. In the second position, the flow channel 14 is semi-closed or constricted for selectively restricting the flow of particles.

It is to be understood that operation of the microstructure may be controlled manually, through a computer program, or through other suitable means. The reversibly actuatable first or second wall (16, 18) may be actuated in response to a signal, for example an electronic signal, mechanical signal, magnetic signal, electromagnetic signal, optical signal, acoustic signal or a combination thereof. The microstructure 10, in response to receiving a signal, applies a force to the reversibly actuatable first or second wall (16, 18) moving the flow channel 14 from a first, open position, to a second, restricted position and/or removes the force F moving the flow channel 14 from a second, restricted position to the first, open position. It is to be understood that the force may be any influence that causes the movement of the reversibly actuatable first or second wall to move between the first and second positions. The force may be a pressure applied to the reversibly actuatable first or second wall.

As illustrated in FIGS. 1A and 1B, the height 38 of the flow channel 14 is greater in the open position than the height 38 of the flow channel 14 in the restricted position. This difference in height 38 is determined by the extent to which the protrusion 20, extending from the first wall 16, extends into the flow channel 14. The length of the protrusion 20 extending into the flow channel 14 determines the height 38 of the flow channel 14 in the second position when the second surface 17 of the second wall 18 abuts the protrusion 20. In the second position, when the second surface 17 of the second wall 18 abuts the protrusion 20, the deflected wall behaves as if the deflected wall has been divided into two individual walls of approximately half the original wall width. The halved walls exhibit the characteristics of a stiffer or more rigid wall as compared to the original single deflected wall and thus, more effectively resist further bending or deflection. The protrusion 20 enables the deflected first or second wall (16, 18) to be substantially parallel to the stationary first or second wall (16, 18). The at least one protrusion 20 is a mechanical constraint such that the opposing first surface of the first wall and the second surface of the second wall are substantially parallel when the flow channel is in the restricted position. The first surface of the first wall and the second surface of the second wall may be substantially parallel when the flow channel is the open position. The ability to selectively control the distance between the first and second opposing walls (16, 18) of the flow channel 14, in other words the height 38 of the flow channel 14, enables the microstructure 10 to separate particles from the flow of particles by trapping the separated particles, for example the less deformable and/or larger particles, at the inlet of the flow channel 14, when the flow channel 14 is in the second position. In turn, selectively controlling the height 38 of the flow channel 14 enables the microstructure 10 to allow the flow of particles, for example a flow of smaller and/or more deformable particles and absent the separated particles, to flow unabated through the flow channel 14, when the flow channel 14 is in both the first and second positions. The ability to allow for the free unabated flow of one particle type through the flow channel while simultaneously trapping and restricting the flow of a second particle type enables separation of these two populations of particles.

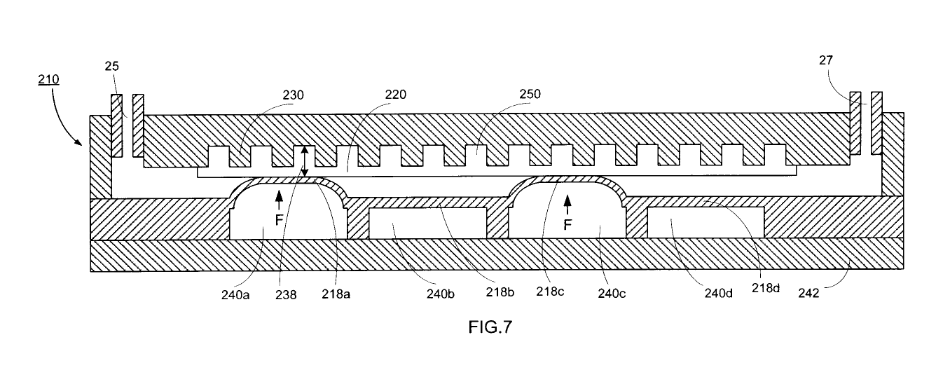

The microstructure 10 may include one or more flow channels 14 extending through the body 12, where the plurality of flow channels are in parallel. A plurality of parallel flow channels 14 enables the microstructure 10 to receive a larger volume and/or separate particles from the flow of particles more quickly than a microstructure having a single flow channel. It is to be understood that a similar configuration to a microstructure having a plurality of parallel flow channels may be achieved by connecting a plurality of microstructures in parallel. Furthermore, a plurality of particle separation microstructures 10 may be connected in series (as discussed below in reference to FIG. 7) or in parallel by any suitable means.

It is to be understood that the microstructure may be used for the separation of a wide variety of particles. The dimensions of the microstructure are selected on the basis of the particle types to be separated. For example, where two particle types are to be sorted, the effective particle diameter for each of the particle types is determined. The minimum flow channel height is selected to permit passage of a first particle type through the flow channel when the flow channel is in both the open and constricted positions, and permit passage of a second particle type, the separated particles, only when the flow channel is in the open position. For example, for completely rigid particles, the effective particle diameter is about equal to the actual particle diameter whereas for deformable particles the effective particle diameter is less than the actual particle diameter as the particle may be compressed and thus deformed when entering the flow channel. The effective particle diameter is dependent on the differential pressure used to infuse the particles into the flow channel. The effective particle diameter may be determined empirically by infusing target particles into a flow channel, where the flow channel height and the pressure differential between the flow channel inlet and flow channel outlet are both known.

The microstructure enables the selective capture of at least one target particle type, elution of a second particle type, and the subsequent release of the captured or trapped target particles for subsequent collection. It is to be understood that the transverse dimension of the flow channel, namely the flow channel width, should not obstruct the passage of particles through the flow channel in either of the open or semi-closed flow channel positions.

It is to be understood that the substantially parallel flow channel surfaces (15 and 17) of the first and second walls (16, 18) in the second position provide a substantially uniform flow channel height 38 and in turn, facilitate the ability of the microstructure to selectively exclude particles of a certain size, rigidity, or combination thereof, irrespective of the lateral position of the particle in the flow channel. Confirmation that the flow channel surfaces are substantially parallel in the second position may be determined by infusing microparticles of a known size into the flow channel, when the flow channel is in the constricted position, and measuring the particle size of the particles passing through the flow channel outlet to confirm the exclusion of particles of certain sizes, and to verify that the selectability of particles of certain sizes is independent of the particles lateral position in the flow channel.

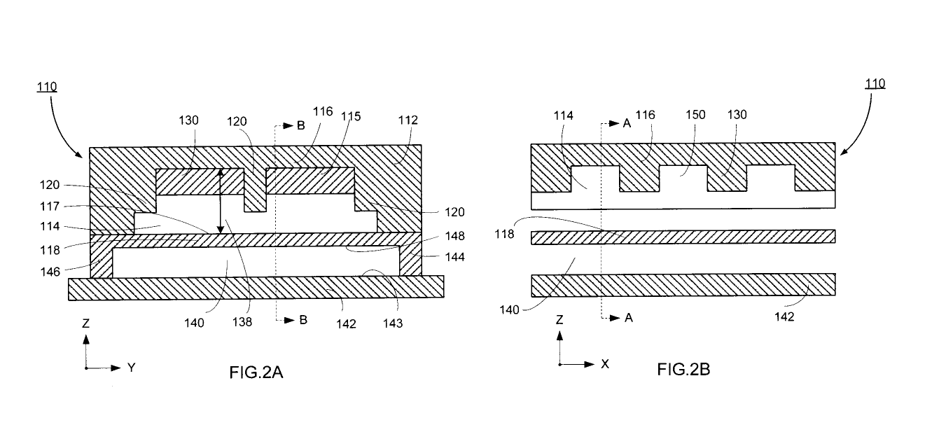

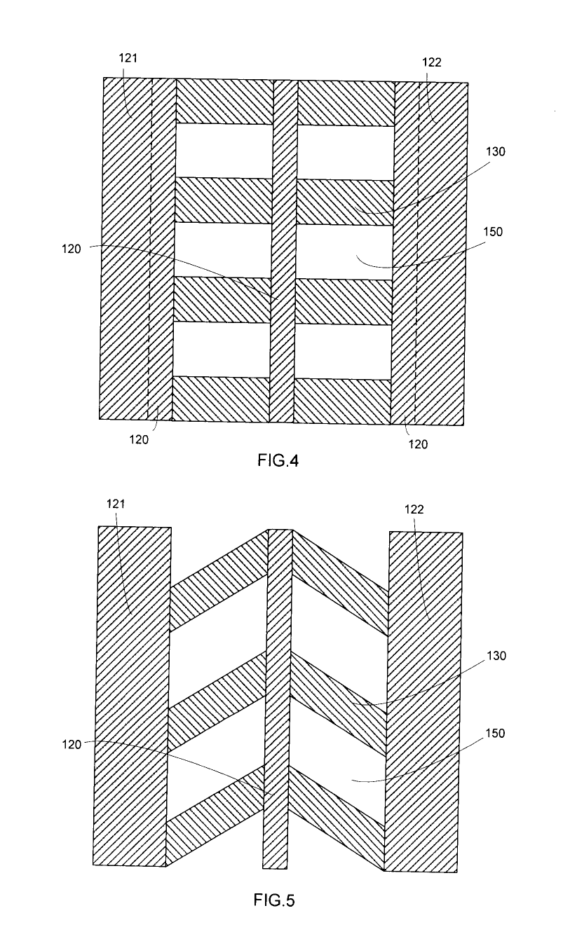

FIGS. 2-4 show a particle separation microstructure 110 according to another embodiment. The microstructure 110 comprises a body 112 having a flow channel 114 and a control channel 140 extending through the body 112.

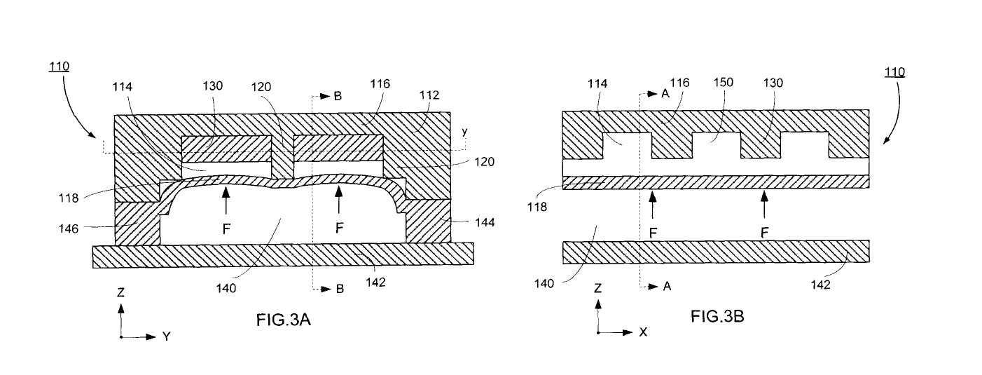

FIG. 2 and FIG. 3 illustrate an embodiment where the second wall 118 is the reversibly actuatable wall. It is to be understood that the control channel 140 may also be defined where the first wall 116 is the reversibly actuatable wall. The control channel 140 is defined by at least a portion of the reversibly actuatable first or second wall (116,118) and an opposing third wall 142. As shown in FIG. 2 and FIG. 3, the control channel 140 is defined by at least a portion of the reversibly actuatable second wall 180, a third wall 142, and a pair of opposing side walls (144, 146), and an opening for receiving a pressurized fluid. The first surface 148 of the second wall 118 and the first surface 143 of the third wall 142 are disposed in an opposing spaced apart relationship.

The control channel 140 applies a force F, where the force F is applied as a pressure, to the reversibly actuatable first or second wall (116,118). As shown in FIGS. 2 and 3, the force F is applied to the reversibly actuatable second wall 118. The control channel 140 may be of any shape or size suitable for applying a force F as described above. For example, the control channel 140 used to apply pressure to the flow channel 114 may be a rectangular cavity situated underneath the flow channel. In one embodiment, the control channel 140 overlaps the flow channel 114 entirely with suitable alignment tolerance. It is to be understood that the control channel 140 may be of different dimensions that the flow channel 114. The flow channel 114 may extend longitudinally beyond the ends of the control channel 140. Alternatively, the control channel 140 may extend laterally beyond the side of the flow channel 114.

The distance between the first and second opposing walls (116, 118) of the flow channel 114, is modulated by the application of a force, for example a positive differential pressure, from the control channel 140 to the flow channel 114 which deflects the actuatable first or second wall (116,118) into contact with the protrusion 120 when the flow channel 114 is in the second position as shown in FIGS. 3A and 3B.

The control channel 140 may have a single opening through which fluid is reversibly moved in and out. Alternatively, the control channel 140 may have a separate inlet and outlet for the movement of fluid into and out of the control channel. Where the control channel 140 has a single port such that the control channel 140 is a ‘dead-end’ chamber or ‘dead-end’ channel, the control channel may be filled with a pressurizing fluid by a dead-end fill to remove any trapped air within the chamber. A “dead-end fill” is a well known method of filling dead-end chambers or dead-end channels with a fluid under pressure. For example, when a fluid is initially injected into a control channel structure, the fluid will follow the path of least resistance, and leave some regions of the control channel unfilled, or partially filled. The gas-permeability of some elastomeric materials used in microfluidic fabrication of flexible membranes may be utilized to allow for dead-end channels to be filled. The control channel fluid may be under a pressure of about 100 mbar to about 4 bar or any amount therebetween. The control channel fluid may be air, water, or any other suitable pressurizable fluids.

The first or second reversibly actuatable wall (116, 118) comprises a flexible material capable of moving between first and second positions. In one embodiment, the first or second reversibly actuatable wall (116, 118) is a flexible membrane formed between the flow channel 114 and control channel 140 which deflects into the flow channel 114 when actuated. The membrane may be of substantially constant thickness, for example between about 10 μm and about 50 μm in thickness, or any thickness therebetween. Flexible membranes in microfluidic devices are known for their use as valves which partially or completely occlude the flow channel.

The flow channel 140 may comprise a plurality of protrusions 20 as shown in FIG. 2A and FIG. 3A. One protrusion 120 may be centrally located in the cross section flow channel 140 such that the central protrusion extends along a central longitudinal axis of the flow channel 140, and one protrusion may be located proximate each of the opposing side walls (121, 122) and extend substantially along each edge of the flow channel, adjacent the flow channel side walls (121, 122). It is to be understood that the flow channel 140 may comprise any number of protrusions that enable the first and second flow channel surface (115, 117) to be substantially parallel when the flow channel is in the second position.

The flow channel 114 may further comprise at least one recess 150 formed in at least one of the first surface 115 of the first wall 116 and the second surface 117 of the second wall 118 for trapping larger, non-deformable particles from the flow of particles when the flow channel is in the second position. These recesses 150 temporarily trap the larger, non-deformable particles within the flow channel when the flow channel is moved from an open to the restricted position and prevent the occlusion of the flow channel 114.

The flow channel 114 may further comprise at least two ribs 130 transversely disposed across the flow channel 114 and extending from the at least one protrusion 120 toward one of the opposing side walls (121,122) to form at least one recess 150 within the flow channel 114 as shown in FIG. 5. The ribs 130 may extend from the protrusion 120 at an angle of about 90 degrees relative to the longitudinal axis of the flow channel. Alternatively, the ribs 130 may extend from the protrusion 120 at an angle between about 30 degrees to about 90 degrees, or any angle in between, relative to a longitudinal axis of the flow channel 114 as shown in FIG. 5. It is to be understood that the ribs 130 extending from a protrusion 120 may abut a side wall (121, 122) or may abut a second protrusion 120 as shown in FIG. 2A and 3A.

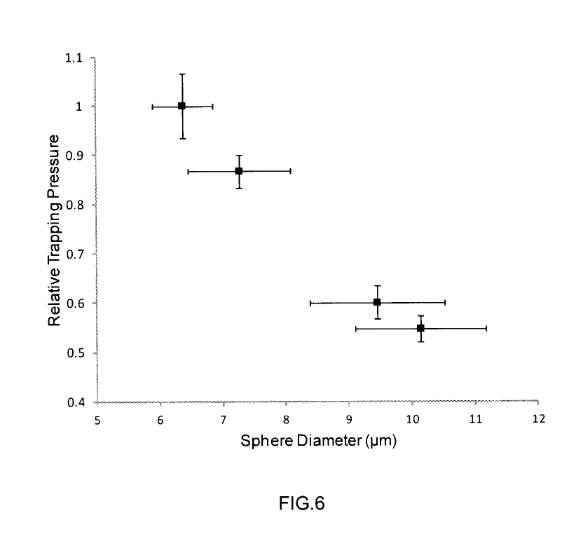

Changes in the distance between the first and second opposing walls (116, 118) of the flow channel 114, in essence the height 138 of the flow channel 114, can be made by adjusting the force applied to the actuatable first or second wall. These changes in force actuate the first or second wall (116, 118) and move the flow channel 114 between the open and restricted positions. By changing the distance between the first and second opposing walls and altering the height 138 of the flow channel, separation of specific particle types may by selected as shown in FIG. 6. It is to be understood that the at least one protrusion extending from the first surface of the first wall of the flow channel may be any shape or size suitable to allow the first and second opposing channel walls to be substantially parallel in at least the second position. FIG. 6 illustrates the pressure required to move the flow channel from a first to a second position to facilitate the entrapment of microspheres of a known size in the flow channel.

In operation, the microstructure receives a flow of particles driven through the flow channel through the application of pressure. Preferably, the pressure may be greater than about 10 mbar and less than 200 mbar, however it is to be understood that the pressure may be any pressure suitable to drive the flow through the flow channel. When the flow channel is in the open position, a heterogeneous mixture flow of particles freely passes through the flow channel in the direction of fluid flow. In the semi-closed or restricted position, only the smaller and/or more deformable particle types within the heterogeneous mixture of particles are capable of passing through the flow channel. The larger and/or more rigid particle types within the heterogeneous mixture of particles are retained at the flow channel inlet and/or within the recesses of the flow channel which act as particle traps. Upon return of the flow channel to the open position, the retained particles are released back into the flow channel to continue to move downstream through the flow channel. Following a flow of particles passing through the flow channel, when the flow channel is in the restricted position, a buffer solution may be introduced into the flow channel to elute any smaller and/or more deformable particle types remaining in the flow channel, prior to the flow channel moving to the open position. Then, when the flow channel is moved into the open position, a buffer solution may be introduced again into the flow channel to elute any larger and/or more rigid particle types trapped in the flow channel. These separate elution phases further enable particle separation.

FIG. 7 shows another embodiment of the microstructure 210 comprising a plurality of control channels (240a, 240b, 240c, 240d) to selectively attenuate the flow of particles in the flow channel 214, as illustrated in FIG. 7. Each of the plurality of control channels (240a, 240b, 240c, 240d) are separately connected and isolated from one another. Each of the control channels (240a, 240b, 240c, 240d) may be substantially perpendicular to the longitudinal axis of the flow channel. Each control channel (240a, 240b, 240c, 240d) modulates the flow through a corresponding portion of the flow channel, where the corresponding portion is illustrated by a shared portion of the reversibly actuatable second wall 218. The control channels (240a, 240b, 240c, 240d) may be filled with a fluid and pressurized at different times, such that each control channel (240a, 240b, 240c, 240d) modulates the flow channel height 238 separately, without changing the overall flow channel 214 volume. For example, the control channels (240a, 240b, 240c, 240d) may be divided into two sets of control channels that are inter-digitated and each set of control channels modulate different portions of the flow channel between the first and second positions. In an initial state, a first set of control channels (240a, 240c) of the particle separation microstructure 210 deflect a portion of the actuatable second wall (218a, 218c) into portions of the flow channel 214, moving those portions of the flow channel into a constricted position, while the second set control channels (240b, 240d) do not deflect portions of the actuatable second wall (218b, 218d) and the corresponding portions of the flow channel 214 remain in an open position. In a second state, the deflection of portions of the actuatable second wall (218a, 218b, 218c, 218d) of the control channels (240a, 240b, 240c, 240d) is reversed such that the first set of control channels (240a, 240c) do not deflect portions of the actuatable second wall (218a, 218c), and the second set of control channels (240b, 240d) deflect portions of the actuatable second wall (218b, 218d) moving the corresponding portions of the flow channel 214 into the constricted position. This dynamic modulation of the particle separation microstructure 210 operates by rapidly moving between these open and restricted flow channel positions, alternating the flow channel geometry without changing the overall flow channel volume. It is to be understood a similar configuration of control channels may be achieved by connecting a plurality of microstructures in series. The control channels of alternating microstructures may be interconnected in order to reduce the number of control channels that must be separately actuated.

Apparatus and Method for Particle Separation

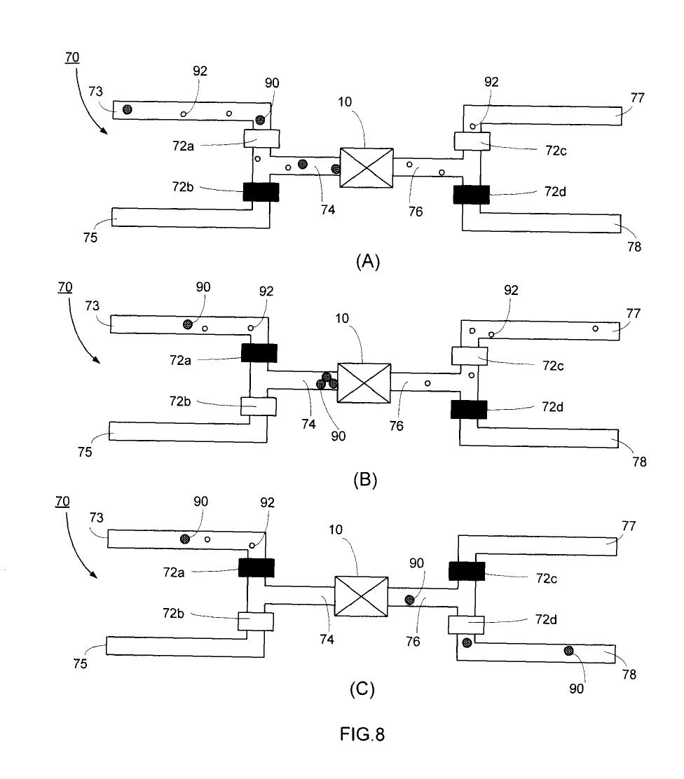

FIG. 8 illustrates an apparatus for the separation of particles. The apparatus 70 comprises at least one microstructure 10, however it is to be understood that a plurality of microstructures 10 may be implemented in parallel or in series as described below, thus alternative embodiments may employ less or more parallelization. The apparatus 70 comprises a plurality of valves (72a, 72b, 72c, 72d) and a plurality of conduits (73, 75, 77, 78) connect to the flow channel inlet 74 or flow channel outlet 76 for receiving and discharging a plurality of different flows. The conduits (73, 75, 77, 78) are connected to the flow channel inlet 74 and flow channel outlet 76 by any suitable means and direct the plurality of flows through the flow channel of the microstructure 10. The open and closed state of the flow control valves (72a, 72b, 72c, 72d) correspond to the open and restricted positions of the flow channel to separate particles from the flow of particles, thus facilitating the selective separation of particle types and subsequent direction of the selected particle types to different conduits.

In one embodiment, the apparatus 70 comprises a sample conduit 73 and a buffer conduit 75 connected to the flow channel inlet 74, and a first particle conduit 77 and a second particle conduit 78 connected to the flow channel outlet 76. The plurality of valves (72a, 72b, 72c, 72d), for example standard microfluidic control valves, control the direction of flow into and out of the flow channel. The inflow control valves 72a, 72b are disposed between each of the sample and buffer conduits respectively (73, 75) and the flow channel inlet 74 of the microstructure for modulating the flows received by the flow channel. The outflow control valves 72c, 72d are disposed between the outlet 76 of the flow channel of the microstructure and each of first particle and second particle conduits respectively (77, 78) for facilitating the individual collection of separated particles. The separated particles may be collected, stored, and extracted.

It will be understood that the particle separation apparatus 70 may include a plurality of conduits for receiving and discharging a plurality of flows for separation of two or more particle types from the flow of particles.

As shown in FIG. 8, the apparatus 70 operates on a 3-stage cycle illustrated in panels (A), (B) and (C). In operation, each of the sample inlet 73 and the buffer inlet 75 are maintained under a pressure greater than the pressure maintained at the first and second particle outlets for driving a flow through the flow channel preferably under a pressure greater than about 20 mbar and less than about 500 mbar. Each of the first particle outlet 77 and the second particle outlet 78 are maintained at about atmospheric pressure.

In the first stage of the operational cycle, illustrated in FIG. 8A, a heterogeneous mixture of particles, comprising target particles 90 and background particles 92, is provided to the flow channel inlet 74 by the sample conduit 73. Inflow control valve 72b is closed preventing the flow of a buffer into the flow channel of the microstructure. Outflow control valve 72d is closed preventing the flow of any particles through second particle conduit 78. Inflow control valve 72a is open permitting the flow of a sample solution comprising a heterogeneous mixture of target 90 and background 92 particles into the flow channel of the microstructure 10. The open state of the inflow control valve 72a and outflow control valve 72c facilitates the flow of particles into the flow channel of the microstructure 10. The microstructure 10 is held in the semi-closed or restricted position at a pressure, preferably not less than about 20 mbar above the sample inlet pressure. The target particles 90 are larger, more rigid, or larger and more rigid than the background particles 92. The target particles 90 are retained at the flow channel inlet 74 of the flow channel of the microstructure 10, while the background particles 92 flow through the flow channel, through outflow control valve 72c, into the first particle conduit 77 where the background particles 92 may be collected.

In the second stage of the operational cycle, illustrated in FIG. 8B, inflow control valve 72a is closed and inflow control valve 72b is opened, to facilitate flow of a buffer solution devoid of particles from the buffer conduit 75 into the flow channel inlet 74 of the microstructure 10 to purge the flow channel of any remaining background particles 92. The microstructure 10 continues to be held in the semi-closed position at a pressure, preferably not less than about 20 mbar above the buffer inlet pressure to facilitate the continued flow through the flow channel and the trapping of the target particles 14. The background particles 92 continue to flow through the flow channel, through outflow control valve 72c, to the first particle conduit 77 where the background particles 92 may be collected.

In the third stage of the operational cycle, illustrated in FIG. 8C, outflow control valve 72c is closed, outflow control valve 72d is opened, and the pressure applied to the actuatable flow channel wall is removed to move the flow channel of microstructure 10 to the open position. A flow of buffer solution from the buffer conduit 75 is introduced into the flow channel inlet 74 to purge the flow channel of the previously entrapped target particles 90. The buffer and the released target particles flow through the flow channel, through outflow control valve 72d, to the second particle conduit 78 where the target particles 90 may be collected.

This three phase operational cycle facilitates the continuous separation of the target particles 90 from background particles 92. Each phase of the operational cycle may be controlled by a user. It is to be understood that the operation of the particle separation apparatus may be controlled manually, through a computer program, or through other suitable means. The length of each stage in the operation cycle is variable and selectable by a user. Effectiveness of the separation of target particles from background particles can be measured by purity, defined as the ratio of target particles with background particles at the second particle conduit 78, or capture efficiency, defined as the ratio of the target particles at the second particle conduit 78 with the background particles at the sample conduit 73. The effectiveness of the separation may be varied by adjusting the period of time spent in each of the three phases. It is to be understood particles collected at the second particle conduit 78 may be re-circulated to the sample conduit 73 and then the process repeated to improve the overall effectiveness of the separation. Furthermore, it is to be understood that the buffer solution is free of particles and is non-reactive with both the microstructure and the flow of particles.

For example, if the initial concentration of target particle, volumetric flow rate, and number of parallelized channels is known then the time required to have a desired number target particles trapped at each parallel connected apparatus can be determined. This estimated time period is a suitable period for the first stage of particle separation operation. It is to be understood that knowledge of the volumetric flow rate enables the estimation of the time required to purge the flow channel of background particles. This purging time is a suitable period for the second stage of operation. A similar period to the purging time is typically required to purge the target particles to the second particle outlet and is a suitable period of time the third stage of operation.

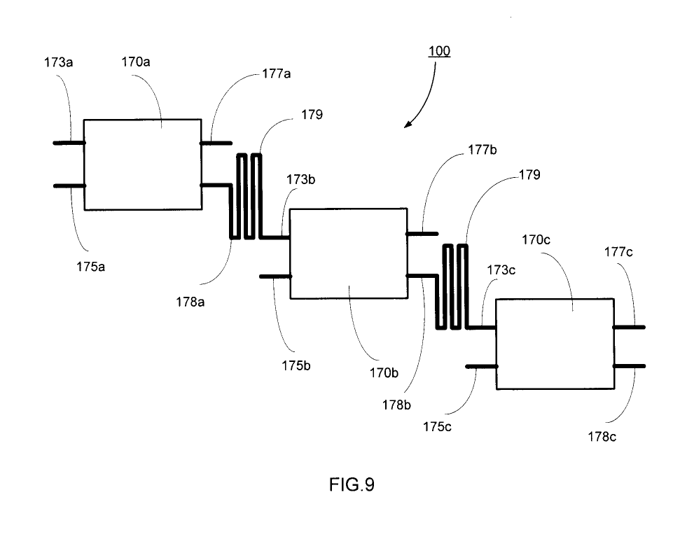

FIG. 9 shows multi-stage apparatus 100 comprising a plurality of serially connected particle separation apparatus 170, comprising sample conduit 173, buffer conduit 175, first particle conduit 177, and second particle conduit 178. Each of the serially connected particle separation apparatus 170 are interconnected at a particle outlet (177, 178) of a first apparatus 170a to the sample inlet 173a of the second apparatus 170 by a connector 179, for example a serpentine shaped conduit. The multistage apparatus 100 facilitates the repeated enrichment of a single sample. Multi-stage serial purification is a process well known in the art wherein an enrichment process which yields a certain purity, for example 90% purity, is implemented multiple times in series to yield a much greater purity, for example three times for 99.9% purity.

Using the multi-stage apparatus 100, the separation method as described above yields a first flow mixture comprising a large concentration of target particles 90 and a small concentration of background particles 92 at the second particle conduit 178a. The concentration of target particles in the flow mixture at second particle conduit 178a is greater the concentration of target particles provided at the sample conduit 173 but may not necessarily have an acceptable purity level. The first flow mixture enters a second apparatus 170b at sample conduit 173b and the separation process is repeated and yields a second flow mixture at the second particle conduit 178b. The second flow mixture then enters a third apparatus 170 c at sample conduit 173c and the separation process is repeated again yielding a third flow mixture at the second particle conduit 178c. The process is repeated a number of times until the desired target particle purity level is achieved.

In one embodiment, serpentine shaped conduits (shown in FIG. 9) may be included in series with and preceding the inflow control valves (72a, 72b) in order to increase the overall hydrodynamic resistance of the flow channel of the microstructure 10, and/or reduce variation in hydrodynamic resistance caused by the deflection of the first or second walls of the flow channel when the device is in use, and/or to temporarily store separated particles from the previous stage.

Method of Selectively Modifying Particle Velocity

In one embodiment, the present disclosure provides a method for selectively attenuating the velocities of specific particle types flowing through a flow channel of the particle separation microstructure 10.

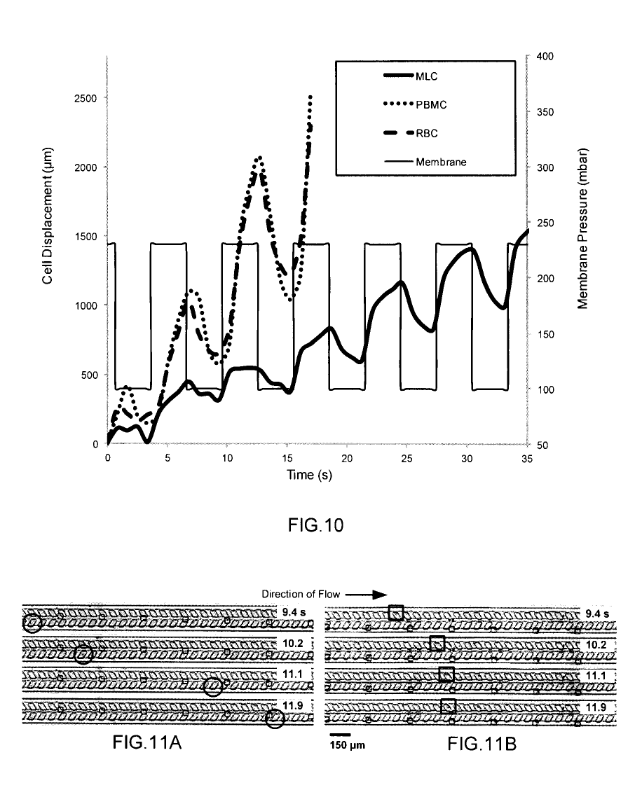

A heterogeneous mixture of a flow of particles is flowed through the flow channel 14 of the microstructure 10 while the control channel 40 is periodically pressurized and depressurized, moving the flow channel between the open and restricted positions, according to a set ‘duty cycle’. A duty cycle is defined as the ratio between the time period the flow channel is in the open position (free flow configuration) and the time period for the flow channel to complete one cycle. One cycle is defined as the period of time that it takes for the flow channel to move from an open position, to a semi-closed or restricted position, and return to an open position. The duty cycle controls the ratio of the velocity of trapped particles versus the free-flowing particles, and thus, facilitates the ability to modulate the average velocities of the particles flowing through the flow channel by determining the length of time the target particles are immobilized in the flow channel 14, within the flow channel recesses 50. The distinct transient flow characteristics of different particle types result in different net velocities that enable particle separation over the length of the flow channel. The net velocity of each particle type in the channel may be estimated using a linear fit of the displacement data graph shown in FIG. 10. The microstructure described herein, having a dynamic flow channel geometry, provides a method to selectively attenuate the flow rate of different particle types based on their physical properties.

The controlled movement of the flow channel between open and restricted positions enables chromatographic separation of particles, for example cells, based on their physical properties of size, deformability, or size and deformability. In liquid chromatography, mixture having a number of different components is infused through a structure, or column, that imparts different flow rates to different components. The difference in flow rate between the different components enables one component of a mixture to be concentrated relative to another component as the mixture travels through the structure. The microstructure described herein can impart different flow rates to different particles based on their physical properties of size, deformability, or size and deformability, where particles trapped by the flow channel in the semi-closed position travel at a slower speed than particles not trapped by the flow channel in the semi-closed position. Therefore, the ability of the microstructure to selectively trap specific particles in the semi-closed position, the microstructure enables a chromatographic separation of these particles.

The time period for the open position (T_{OPEN}) and semi-closed position (T_{SC}), initial flow pressure and the pressure of the flow channel during the open position (P_{OPEN}) and semi closed position (P_{SC}) may be determined by calculation or may be determined empirically. For example, T_{OPEN} may range from about 0.5 to about 20 seconds, or any amount therebetween, for example about 1, 2, 3, 4,5, 6, 7, 8, 9, 10, 11, 12, 13, 14, 15, 16, 17, 18, or 19 seconds, or any amount therebetween. As an example, T_{SC} may range from about 0.5 to about 20 seconds, or any amount therebetween, for example about 1, 2, 3, 4,5, 6, 7, 8, 9, 10, 11, 12, 13, 14, 15, 16, 17, 18, or 19 seconds, or any amount therebetween. As an example, P_{OPEN} may range from about 20 mbar to about 500 mbar or any amount therebetween, for example about 30, 40, 50, 60, 70, 80 90, 100, 110, 120, 130, 140, 150, 160, 170, 180, 190, 200, 210, 220, 230 , 240, 250, 260, 270, 280, 290, 300, 350, 400, 450, or any amount therebetween. As an example, P_{SC} may range from about 20 mbar to about 500 mbar or any amount therebetween, for example about 30, 40, 50, 60, 70, 80 90, 100, 110, 120, 130, 140, 150, 160, 170, 180, 190, 200, 210, 220, 230, 240, 250, 260, 270, 280, 290, 300, 350, 400, 450 or any amount therebetween. The duty cycle may be determined from these values as described above, and may range from about 0.1 to 1.0 or any amount therebetween, for example about 0.2, 0.3, 0.4, 0.5, 0.6, 0.7, 0.8 or 0.9, or any amount therebetween.

Modulation of the flow channel geometry continuously disturbs the contact between the particles and the microstructure of the flow channel, thereby reducing the potential for particle adsorption and clogging problems that plague traditional filtration-based particle separation methods. By altering the operating duty cycle of the particle separation apparatus, adsorption of particles to inner surfaces of the flow channel, and obstruction of the flow channel is decreased or prevented. Modulation of the flow channel duty cycle facilitates the ability of a user to control the trapped particle density in the dynamic flow channel, which in turn enables a user to vary the incoming flow of target particle populations in real-time.

The pressure of the fluid applied to the flow channel (flow pressure) may be non-zero, or, from about 5 mbar to about 50 mbar, or any amount therebetween. For example about 10, 15, 20, 25, 30, 35, 40 or 45 mbar, or any amount therebetween.

Apparatus Fabrication

Multilayer soft lithography (MSL) is a well-known fabrication technique that allows for facile and robust fabrication of microfluidic devices having hundreds to thousands of microscopic reaction chambers, valves, pumps, fluidic logic elements and other components. Xia & Whitesides, 1998 (Angewandte Chemie-International Edition 37:551-575; herein incorporated by reference) describe and review procedures, material and techniques for soft lithography, including MSL.

The general idea of multilayer soft lithography (MSL) is to iteratively stack layers of polymers, for example polydimethylsiloxane (PDMS), of varying thickness on top of each other. Thin and thick layers of PDMS with stoichiometric ratios of base and hardener, respectively less than and higher than 10:1 are formed on separate wafers. For example, a thinner layer may be obtained using a base:hardener ratio of 20:1 and spun onto a silicon wafer substrate. A thicker layer may be obtained using a base:hardener ratio of 5:1. Photoresist patterns previously made on the wafers will define the microfluidic channels of the device, for example the flow channels and the control channels. The thick layer is then peeled away from the wafer and placed on top of the thin wafer. After baking, the excess components in each layer will bond and form a PDMS ‘chip’ composed of two layers of channels. Methods of working with elastomers and applying them in microfluidic applications are known in the art; see U.S. Pat. No. 6,929,030; Scherer et al. Science 2000, 290, 1536-1539; Unger et al. Science 2000, 288, 113-116; McDonald et al. Ace. Chem. Res. 2002, 35, 491-499; Thorsen, T. et al,. Science 2002, 298, 580-584; Liu, J. et al. Anal. Chem. 2003, 75, 4718-4723; Rolland et al. 2004 JACS 126:2322- 2323, PCT publications WO 02/43615 and WO 01/01025.

Various polymers, including but not limited to soft polymers, may be used in microfluidic devices and systems. Examples of polymers that may be useful in fabrication of all, or a portion of a microfluidic device according to various aspects of the invention include elastomers. Elastomers may be generally characterized by a wide range of thermal stability, high lubricity, water repellence and physiological inertness. Other desirable characteristics of elastomers may vary with the application. It is within the ability of one of skill in the art to select a suitable elastomer or combination of elastomers for the desired purpose. Examples of elastomers include silicone, PDMS, photocurable perfluoropolyethers (PFPEs), fluorosilicones, polyisoprene, polybutadiene, polychloroprene, polyisobutylene, polyurethanes, poly(styrene-butadiene-styrene), vinyl-silane crosslinked silicones, and the like. Elastomers may be optically clear, or may be opaque, or have varying degrees of transparency. In some embodiments of the present disclosure, it may be desirable to use a biocompatible elastomer. PDMS is one of the first developed and more widely used elastomers in soft lithography applications. Where PDMS is described as the elastomer used in various embodiments of the invention, it is for exemplary purposes only, and the choice of alternate elastomers is within the knowledge of one skilled in the art. A variety of elastomers suitable for use in microfluidic applications, and their various properties and examples of applications are described in U.S. Pat. No. 6,929,030.

Other components may be incorporated into the particle separation apparatus during fabrication—micron-scale valves, pumps, channels, fluidic multiplexers, perfusion chambers and the like may be integrated during MSL. Methods of making and integrating such components are described in, for example, U.S. Pat, Nos. 7,144,616, 7,113,910, 7,040,338, 6,929,030, 6,899,137, 6,408,878, 6,793,753, 6,540,895; US Patent Applications 2004/0224380, 2004/0112442; PCT Applications WO 2006/060748.

Once fabricated, one or more walls of a flow channel, via or other space within the microstructure may be treated or coated with a surface treatment agent. For example, the channels, via or other space may be temporarily filled with a fluid comprising bovine serum albumin (BSA) or a polymer (e.g. to prevent or reduce non-specific adhesion of particles, particularly cells. Examples of such polymers include polyethylene glycol of varying polymer molecular weight, such as are available in the art. One of skill in the art will be able to select a suitable polymer size and concentration to deposit sufficient polymer or protein on the surface, while maintaining a suitable viscosity to allow for handling and fluid flow within the device when preparing the treatment. Following treatment of the surface, the flow channel, via or other space may be flushed with a second fluid (e.g. a buffer, media, phosphate buffered saline (PBS) or the like) to remove any leftover albumin or polymer.

It is to be understood a microstructure is a structure comprising features where one or more dimensions measure less than about 1 mm.

The heterogeneous mixture of a flow of particles may comprise at least two or more types of particles or species of particles or populations of particles. The types or species or populations of particles may differ in size, rigidity, or both size and rigidity. Additionally, one or more of the particles may comprise a selectable marker, or an identifiable marker.

A particle may be any discrete material which can be flowed through a microscale system. For example particles may include beads, cells and the like. For example, polymer beads (e.g., polystyrene, polypropylene, latex, nylon and many others), silica or silicon beads, clay or clay beads, ceramic beads, glass beads, magnetic beads, metallic beads, inorganic compound beads, and organic compound beads can be used. A variety of particles are commercially available, e.g., those typically used for chromatography (see, e.g., the 1999 Sigma “Biochemicals and Reagents for Life Sciences Research” Catalog from Sigma (Saint Louis, Mo.), e.g., pp. 1921-2007; The 1999 Suppleco “Chromatography Products” Catalogue, and others), as well as those commonly used for affinity purification (e.g., Dynabeads™ from Dynal, as well as many derivatized beads, e.g., various derivatized Dynabeads™ (e.g., the various magnetic Dynabeads™, which commonly include coupled reagents) supplied e.g., by Promega, the Baxter Immunotherapy Group, and many other sources).

Particles may be suspended in any suitable fluid, including buffer, saline, water, culture medium, blood, plasma, serum, cell or tissue extract, urine or the like, or a combination thereof.

Cells may be obtained from, or found within, for example, cell culture, an environmental sample, a subject's body fluids, or a tissue sample. Cells may be eukaryotic cells, including plant cells. A cell culture may be included in a process for isolating, enriching, or isolating and enriching one or more particular cell types or cell species. Tissue samples may be obtained by, for example, curettage, exfoliation, tissue scraping or swabbing, needle aspiration biopsy or needle (core) biopsy, incisional biopsy for sampling tissue, or excisional biopsy, which may entail total removal of the tissue of interest. Body fluids include, for example, blood, bone marrow, plasma, serum, adipose tissue, sputum, urine, semen, amniotic fluid, cord blood, cerebrospinal fluid or the like.

An environmental sample may comprise a fluid and one or more species of particle. For example, the environmental sample may comprise fresh or salt water (e.g. seawater, lake water, water from a treatment facility, sewer outflow or other water samples that may be acquired when monitoring a location or environment. The environmental sample may comprise soil, plant matter, or other matter that may be found when monitoring a location or environment. The environmental sample may comprise particles, such as those exemplified herein, including eukaryotic cells, and/or prokaryotic cells, and/or minerals, particulates or the like.

A subject may be an animal, such as a mammal, reptile, bird or fish; examples of mammals include a rodent, cat, dog, primate, sheep, cow, pig, horse or ferret; examples of rodents include a mouse, rat, guinea pig or hamster; examples of primates include a human, a monkey, chimpanzee, rhesus macaque or green monkey.

Examples of cells include red blood cells, white blood cells, peripheral blood mononucleocyte (PBMC), stem cells, tumor cells, cancer cells (primary or immortalized), animal or human cell lines (primary cell lines or immortalized cell lines) and the like. Examples of stem cells include adult stem cells, somatic stem cells, embryonic stem cells, non-embryonic stem cells, pluripotent stem cells, induced pluripotent stem cells, totipotent stem cells, multipotent stem cells, unipotent stem cells, hematopoetic stem cells, neural stem cells, mesenchymal stem cells, endothelial stem cells, and the like Cancer cells may be from any type of cancer or tumor. Non-limiting examples of different types of cancers and tumors include: carcinomas, such as neoplasms of the central nervous system, including glioblastoma, astrocytoma, oligodendroglial tumors, ependymal and choroid plexus tumors, pineal tumors, neuronal tumors, medulloblastoma, schwannoma, meningioma, and meningeal sarcoma; neoplasms of the eye, including basal cell carcinoma, squamous cell carcinoma, melanoma, rhabdomyosarcoma, and retinoblastoma; neoplasms of the endocrine glands, including pituitary neoplasms, neoplasms of the thyroid, neoplasms of the adrenal cortex, neoplasms of the neuroendocrine system, neoplasms of the gastroenteropancreatic endocrine system, and neoplasms of the gonads; neoplasms of the head and neck, including head and neck cancer, neoplasms of the oral cavity, pharynx, and larynx, and odontogenic tumors; neoplasms of the thorax, including large cell lung carcinoma, small cell lung carcinoma, non-small cell lung carcinoma, malignant mesothelioma, thymomas, and primary germ cell tumors of the thorax; neoplasms of the alimentary canal, including neoplasms of the esophagus, stomach, liver, gallbladder, the exocrine pancreas, the small intestine, veriform appendix, and peritoneum, adneocarcinoma of the colon and rectum, and neoplasms of the anus; neoplasms of the genitourinary tract, including renal cell carcinoma, neoplasms of the renal pelvis, ureter, bladder, urethra, prostate, penis, testis; and female reproductive organs, including neoplasms of the vulva and vagina, cervix, adenocarcinoma of the uterine corpus, ovarian cancer, gynecologic sarcomas, and neoplasms of the breast; neoplasms of the skin, including basal cell carcinoma, squamous cell carcinoma, dermatofibrosarcoma, Merkel cell tumor, and malignant melanoma; neoplasms of the bone and soft tissue, including osteogenic sarcoma, malignant fibrous histiocytoma, chondrosarcoma, Ewing's sarcoma, primitive neuroectodermal tumor, and angiosarcoma; neoplasms of the hematopoietic system, including myelodysplastic sydromes, acute myeloid leukemia, chronic myeloid leukemia, acute lymphocytic leukemia, HTLV-I and T-cell leukemia/lymphoma, chronic lymphocytic leukemia, hairy cell leukemia, Hodgkin's disease, non-Hodgkin's lymphomas, and mast cell leukemia; and neoplasms of children, including acute lymphoblastic leukemia, acute myelocytic leukemias, neuroblastoma, bone tumors, rhabdomyosarcoma, lymphomas, renal tumors, and the like.

Where the particle is a cell, separation of one or more cell types or species from another in media, blood or other fluid has several applications. Without limitation, such applications may include leukapheresis, blood bank processing, separation of asynchronous cells in culture, enrichment of selected cell types (e.g. stem cells from cord blood or bone marrow or adipose tissue), identification and/or enumeration of rare cell types (e.g. circulating tumor cells in the blood). Such circulating tumor cells may be of particular diagnostic, prognostic or clinical interest as markers of the development and extent of cancer and/or metastasis. Circulating tumor cells (CTC) demonstrate physical differences from other hematological cells, namely size and rigidity. These physical differences may be able to be exploited in other cell types such as white blood cells (WBCs), cardiac myocytes, mesenchymal stem cells (MSCs), and pluripotent stem cells. Additionally, it may be beneficial to separate red blood cells from other cells in a blood sample to facilitate subsequent analysis. For example, the polymerase chain reaction (PCR) and considerable effort has been expended miniaturizing this reaction. Haemoglobin in RBCs is an inhibitor of the PCR reaction and thus the presence of RBCs is detrimental in PCR reactions. This phenomenon motivated research in WBC enrichment with Carlson et al in 1997 and Wilding et a/ in 1998.

### EXAMPLES

### Example 1

### Microfabrication

An embodiment of the particle separation microstructure of the present disclosure, shown in FIG. 2, having a dynamically adjustable flow channel height is a two-layer microstructure fabricated using multilayer soft lithography of polydimethylsiloxane (PDMS) silicone. Multilayer soft lithography (MSL) is a well-known fabrication technique that allows for facile and robust fabrication of microfluidic devices having hundreds to thousands of microscopic reaction chambers, valves, pumps, fluidic logic elements and other components. Xia & Whitesides, 1998 (Angewandte Chemie-International Edition 37:551-575; herein incorporated by reference) describe and review procedures, material and techniques for soft lithography, including MSL.

Molds for the flow layer comprising the flow channel microstructure and the control layer comprising the control channel microstructure were fabricated separately on silicon wafers. The flow layer was fabricated in four photolithographic steps to facilitate the required flow layer geometry. The control layer was fabricated in a single photolithographic step. The patterns for all five masks were drawn using Solidworks DWG Editor.

The SU-8 part of the flow layer mold was fabricated on a cleaned 100 mm silicon wafer. After dehydration baking on a hotplate at 200° C. for 5 min, SU-8 3010 was spread onto the wafer at 500 rpm for 10 seconds, and then spun at 2250 rpm for 30 s. The wafer was then soft baked at 95° C. on the hot plate for 5 minutes before being exposed to UV light in a mask aligner for 90 s. The exposed wafer was given a post exposure bake in the sequence of 65° C. for 1 minute, 95° C. for 5 minutes and then 65° C. for 1 minute. The wafer was then developed using SU-8 developer (MicroChem). A second layer of SU-8 3005 was spread onto the wafer at 500 rpm for 10 seconds, and then spun at 3000 rpm for 30 s. The wafer was then soft baked at 95° C. on the hot plate for 5 minutes before being exposed to UV light in a mask aligner for 60 s The exposed wafer was given a post exposure bake in the sequence of 65° C. for 1 minute, 95° C. for 3 minutes and then 65° C. for 1 minute. The wafer was then developed using SU-8 developer (MicroChem). A third layer of SU-8 3025 was spread onto the wafer at 500 rpm for 10 seconds, and then spun at 4000 rpm for 30 s. The wafer was then soft baked at 95° C. on the hot plate for 5 minutes before being exposed to UV light in a mask aligner for 60 s The exposed wafer was given a post exposure bake in the sequence of 65° C. for 1 minute, 95° C. for 5 minutes and then 65° C. for 1 minute. The wafer was then developed using SU-8 developer (MicroChem). The SPR part of the flow layer was added to the silicon wafer containing the SU-8 microstructures. SPR 220-7.0 photoresist was spin-coated on the wafer at 550 rpm for 50 s, and the resultant edge bead was removed manually. The coated wafer was soft baked on hotplates set at 65° C. for 1 minute, 95° C. for 3 minutes, and then 65° C. for 1 minute. The designed mask for the SPR pattern was then aligned with the SU-8 pattern and exposed in 5 30 s bursts with a 30 second interval between bursts. After waiting for approximately 30 min, the wafer was developed using MF-319 developer (MicroChem). Finally, the developed wafer was annealed for 10 min on a 95° C. hotplate to create a rounded channel profile. The control layer is made from SU-8 3025 and fabricated in the same protocol as second SU-8 layer of the flow layer.

Silicon wafers containing the flow channel and control channel were replicated using a plastic molding technique.(S. P. Desai, D. M. Freeman and J. Voldman, Lab Chip, 2009, 9, 1631-1637). The microstructure was fabricated from PDMS plastic molds using multilayer soft-lithography of RTV 615 silicone (Momentive Performance Materials). The control channel was spun onto a plastic copy of the silicon wafer at 1800 rpm. The flow channel was cast molded from its plastic master and diffusion bonded to the control layer in a 65° C. oven for 1 hour. The bonded devices were cut and punched using a 0.5 mm diameter punch (Technical Innovations, Angleton, Tex., USA) to create fluid ports. In preparation for bonding, both the PDMS devices and clean glass slides were activated using 40 s of air plasma (Harrick Plasma, Ithaca, N.Y., USA). The completed microstructure was prepared for experiments by initially filling the control channels with de-ionized water using 200 mbar of pressure. Subsequently, the flow channels were infused with phosphate buffered saline containing 5% bovine serum albumin, and incubated for 30 minutes to prevent non-specific adsorption of the cells onto the surface of the PDMS.

### Example 2

### Particle Separation Analysis

A suspension of rigid polystyrene microspheres of known size (Bangs Labs) were flowed through the separation channel. The flow channel was initially in the open position and all microspheres passed through the channel unimpeded. The pressure applied to the flow channel by the control channel was gradually increased as microspheres continued to flow through the channel. As the pressure applied increased, the flexible membrane was deflected into the flow channel effectively moving the flow channel into the second, restricted position, thereby decreasing the flow channel height along the length of the flow channel. The pressure required to move the flow channel into the second position, and in turn, trap a single microsphere from the suspension, about half of microspheres from suspension, and almost all microspheres from suspension were recorded. The point at which almost all the microspheres from the suspension were trapped is indicative of the point at which the flow channel reached the second position, and the first and second opposing flow channel surfaces were substantially parallel. These three measurements are indicated in FIG. 7 by the bottom error bound, data point, and top error bound respectively. This experiment was repeated for three different suspensions of microspheres, where the microspheres in each of the three suspensions had a diameter 6.47 μm, 7.27 μm, 9.45 μm, and 10.14 μm respectively. The results illustrated in FIG. 7 clearly show the pressure required to move the flow channel from an open position to a semi-closed position. Manufacturer quoted standard deviation in microsphere diameter form error bounds in sphere diameter.

The results illustrate that larger particles require substantially less pressure to be captured or trapped at the inlet or within the flow channel than smaller particles, indicating that particle selectability on the basis of size and deformability may be facilitated by moving the flow channel between a first and second position by controlling the magnitude of the pressure applied to the flow channel.

### Example 3

### Particle Velocity Analysis

L1210 mouse lymphoma cells were grown in suspension culture using RPMI 1640 (Invitrogen) containing 10% fetal bovine serum and 1% penicillin/streptomycin, at 37° C. in a 100% humidified atmosphere containing 5% CO2. The cell suspension was diluted using phosphate buffered saline containing 5% bovine serum albumin. Cell viability was assessed using L3224 LIVE/DEAD Viability/Cytotoxicity Kit (Invitrogen) following the manufacturer's instructions. Peripheral blood mononuclear cells were prepared from whole blood collected from healthy volunteers following informed consent. Whole blood was drawn into 6 mL sodium heparin containing tubes. Peripheral blood mononuclear cells were obtained using Histopaque 1077 (Sigma-Aldrich) according to manufacturer's instructions, and then resuspended at a concentration of 10×10⁶ cells per mL in AIM 5 media (Invitrogen). Red blood cells were purified from whole blood and used within 48 hours of donation. Before testing, each of the three cell types was re-suspended to a concentration of 7×10⁸ cells per mL. Fluids infused into the microstructure were supplied from 15 mL sealed conical tubes (Fisher Scientific) with custom fabricated caps that enable the tubes to act as pressurized reservoirs. The liquid connection between the reservoirs and the microstructure was made using 0.5 mm ID flexible Tygon tubing (Cole-Parmer). The microstructure -to-tube interface was created using 19 mm long 23 gauge stainless steel tubing (New England Small Tube, Litchfield, N.H., USA) that forms a stretch seal between the PDMS device and the Tygon tubing. A multi-channel pressure control system (Fluigent MFCS-4C, France) was used to pressurize the reservoirs connected to the flow channel. A custom-made pressure control system was used to pressurize the reservoirs connected to the control channel to deflect the flexible membrane and move the flow channel into the restricted position. Pressure applied to the control channel could be turned on and off automatically using solenoid valves controlled by a MSP430 microprocessor (Texas Instruments) and custom developed PC software.

Videos of the cell motion inside the microchannel were acquired using a Nikon Ti-U inverted microscope and a Nikon DS-2MBW CCD camera. The displacement of individual cells was measured using frame-by-frame tracking in the captured videos. The net velocity of each cell was determined using the slope of a linear fit to the displacement data. Cell diameters were measured in suspension using the Nikon NIS-Elements image capture software supplied with the CCD camera.

The results illustrate that red blood cells (RBCs) are highly deformable, discoid-shaped cells with an 8 mm diameter and a 2 mm thickness. Because the dimensions of RBCs are small relative to the length scale of the microstructures, these cells essentially follow the flow of the bulk liquid. PBMCs primarily consist of lymphocytes and have a measured mean diameter of 7.2 mm with a standard deviation of 0.6 mm. MLCs were grown from an immortalized cell line and used in experiments between 4 and 6 days after passage. During this period, these cells had a mean diameter of 10.0 mm with a standard deviation of 1.4 mm. MLCs were chosen because their size and shape are somewhat similar to PBMCs, but their rigidity is likely to be significantly greater because of their enlarged nucleus.

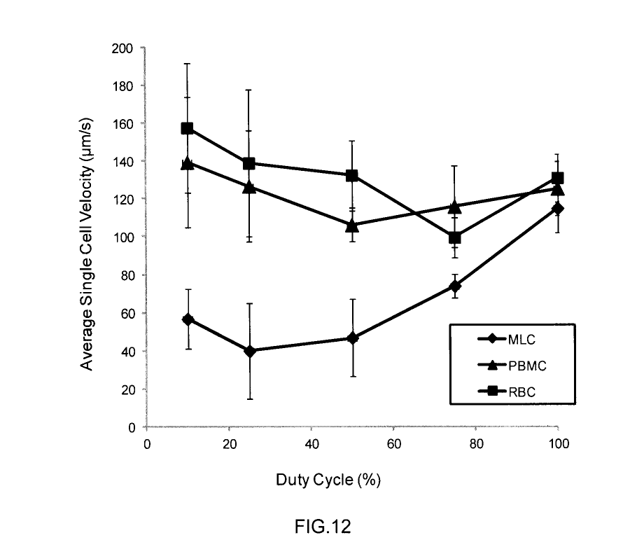

The flow properties of each of the three cell types in the dynamic micro flow channel were tracked by following the displacement of individual cells over a fixed 2500 mm section of the micro flow channel. Representative cell displacement data graphs and video images are shown in FIG. 10 and FIG. 11. The sample fluid was infused into the micro flow channel with a pressure of 20 mbar, while the membrane inflation pressure was modulated between 100 mbar for the open flow channel position and 230 mbar for the semi-closed flow channel position. The time to complete one cycle, i.e. for the membrane to move from the first position, to the second position, and return to the first position, had a period of 6 seconds and a duty cycle of 50%. The timing of each data graph was adjusted to match the phase of the membrane cycles in FIG. 9. Cell viability was checked repeatedly along the length of the microchannel using the fluorescence signal produced by the L3224 LIVE/DEAD viability assay (Invitrogen). No changes in cell viability were observed, which is consistent with previous observations of eukaryotic cells compressed by PDMS membrane microvalves.

FIG. 12 shows the duty cycle dependence of the average velocity of each of the three cell types. These measurements were taken with open and semi-closed flow channel positions at flow channel pressures set at 100 and 230 mbar respectively. The average velocity of MLCs shows a decreasing trend as the duty cycle is reduced from 100%, whereas the net flow rates of PBMCs and RBCs are nearly identical to each other and show little dependence on duty cycle. The average velocity of PBMCs and RBCs shows a general tendency to increase at lower frequencies. This trend results from reduced interactions between these cells and the surfaces of the dynamic microchannel. Below a 40% duty cycle, the average velocity of MLCs also begins to increase with decreasing duty cycle. Similar to over-pressurizing the flow channel, this property is caused by the motion of the membrane that excludes some of the larger MLCs because the length of time the flow channel is in the open position is insufficient for these cells to enter the micro flow channel.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

### REFERENCES

1. Mark J E. Polymer data handbook. New York: Oxford University Press; 1999.
2. Quake S R, Scherer A. From micro- to nanofabrication with soft materials. Science. 2000 Nov. 24; 290(5496):1536-40.
3. Xia Y, Whitesides G M. Soft lithography. Annual Review of Materials Science. 1998 Aug. 1; 28(1):153-84.
4. Effenhauser C S, Bruin G J M, Paulus A, Ehrat M. Integrated capillary electrophoresis on flexible silicone microdevices: Analysis of DNA restriction fragments and detection of single DNA molecules on microchips. Anal Chem. 1997 Sep. 1; 69(17):3451-7.
5. Quake S R, Scherer A, Spence C, Chou H P. In: Gourley P L, editor. Microfabricated devices for sizing DNA and sorting cells. Micro- and nanofabricated structures and devices for biomedical environmental applications; 1998; ; 1998.
6. Fu A Y, Chou H, Spence C, Arnold F H, Quake S R. An integrated microfabricated cell sorter. Anal Chem. 2002 Jun. 1; 74(11):2451-7.
7. Unger M A, Chou H P, Thorsen T, Scherer A, Quake S R. Monolithic microfabricated valves and pumps by multilayer soft lithography. Science. 2000 Apr. 7; 288(5463):113-6.
8. Hansen C. Microfluidic technologies for structural biology [dissertation]; 2004.
9. Vollmer A P, Probstein R F, Gilbert R, Thorsen T. Development of an integrated microfluidic platform for dynamic oxygen sensing and delivery in a flowing medium. Lab Chip. 2005; 5:1059-66.
10. Lee J N, Jiang X, Ryan D, Whitesides G M. Compatibility of mammalian cells on surfaces of poly(dimethylsiloxane). Langmuir. 2004 Dec. 1; 20(26):11684-91.
11. Simpson, T. R. E. et al. Influence of interfaces on the rates of crosslinking in poly (dimethyl siloxane) coatings. Journal of polymer science. 2004; 42(6):1421.
12. Melin J, Quake S R. Microfluidic large-scale integration: The evolution of design rules for biological automation. Annu Rev Biophys Biomol Struct. 2007 Jun. 1; 36(1):213-31.
13. VanDelinder V, Groisman A. Perfusion in microfluidic cross-flow: Separation of white blood cells from whole blood and exchange of medium in a continuous flow. Anal Chem. 2007 Mar. 1; 79(5):2023-30.
14. Goulpeau J, Trouchet D, Ajdari A, Tabeling P. Experimental study and modeling of polydimethylsiloxane peristaltic micropumps. J Appl Phys. 2005 Aug. 15; 98(4):044914.
15. Kartalov E P, Scherer A, Quake S R, Taylor C R, Anderson W F. Experimentally validated quantitative linear model for the device physics of elastomeric microfluidic valves. J Appl Phys. 2007 Mar. 15; 101(6):064505-1,064505-4.
16. Squires T M, Quake S R. Microfluidics: Fluid physics at the nanoliter scale. Rev Mod Phys. 2005 Oct. 6; 77(3):977.
17. Bruus H. Theoretical microfluidics—capillary effects. In: Oxford University Press; 2008. p. 123-41.
18. Stone H. Introduction to fluid dynamics for microfluidic flows. CMOS Biotechnology. 2007:5-30.
19. Thorsen T, Maerkl S J, Quake S R. Microfluidic large-scale integration. Science. 2002 Oct. 18; 298(5593):580-4.
20. Ajdari A. Steady flows in networks of microfluidic channels: Building on the analogy with electrical circuits. Comptes Rendus Physique. 2004 6; 5(5):539-46.
21. Dondelinger R M. Hematology analyzers. Biomedical Instrumentation & Technology. 2009; 43(4):300-4.
22. The human heart—blood [homepage on the Internet]. 2010. Available from: http://www.fi.edu/learn/heart/blood/blood.html.
23. Chu R W. Leukocytes in blood transfusion: Adverse effects and their prevention. Hong Kong Med J; 5(3):280-4.
24. Toner M, Irimia D. Blood on a chip. Annu Rev Biomed Eng. 2005 Aug. 15; 7(1):77-103.
25. Guller U, Zajac P, Schnider A, Bosch B, Vorburger S, Zuber M, et al. Disseminated single tumor cells as detected by real-time quantitative PCR represent a prognostic factor in patients undergoing surgery for colorectal cancer. Ann Surg. 2002 December; 236(6):768-76.
26. Koch M, Kienle P, Kastrati D, Antolovic D, Schmidt J, Herfarth C, et al. Prognostic impact of hematogenous tumor cell dissemination in patients with stage II colorectal cancer. International Journal of Cancer. 2006; 118(12):3072-7.
27. Thorban S, Rosenberg R, Maak M, Friederichs J, Gertler R, Siewert J. Impact of disseminated tumor cells in gastrointestinal cancer. Expert Review of Molecular Diagnostics. 2006 May 1; 6(3):333-43.
28. Elshimali Y I, Grody W W. The clinical significance of circulating tumor cells in the peripheral blood. Diagnostic Molecular Pathology. 2006 December; 15(4):187-94.
29. Reuben J M, Krishnamurthy S, Woodward W, Cristofanilli M. The role of circulating tumor cells in breast cancer diagnosis and prediction of therapy response. Expert opinion. 2008; 2(4):339.
30. Urtishak S, Alpaugh R K, Weiner L M, Swaby R F. Clinical utility of circulating tumor cells: A role for monitoring response to therapy and drug development. Biomarkers in Medicine. 2008 Apr. 1; 2(2):137-45.
31. Pappas D, Wang K. Cellular separations: A review of new challenges in analytical chemistry. Anal Chim Acta. 2007 Oct. 3; 601(1):26-35.
32. Murthy S, Sethu P, Vunjak-Novakovic G, Toner M, Radisic M. Size-based microfluidic enrichment of neonatal rat cardiac cell populations. Biomed Microdevices. 2006 Sep. 1; 8(3):231-7.
33. Alberts Bea. Molecular biology of the cell. In: 4th ed.; 2002.
34. Bao G, Suresh S. Cell and molecular mechanics of biological materials. Nat Mater. 2003 print; 2(11):715-25.
35. Tan J L, Tien J, Pirone D M, Gray D S, Bhadriraju K, Chen C S. Cells lying on a bed of microneedles: An approach to isolate mechanical force. PNAS. 2003 Feb. 18; 100(4):1484-9.
36. Galbraith C , Sheetz M P. A micromachined device provides a new bend on fibroblast traction forces. Proceedings of the National Academy of Sciences of the United States of America. 1997 Aug. 19; 94(17):9114-8.
37. Rosenbluth M J, Lam W A, Fletcher D A. Force microscopy of nonadherent cells: A comparison of leukemia cell deformability. Biophys J. 2006 Apr. 15; 90(8):2994-3003.
38. Sarah E Cross ea. AFM-based analysis of human metastatic cancer cells. Nanotechnology. 2008; 19(38):384003.
39. Yap B, Kamm R D. Mechanical deformation of neutrophils into narrow channels induces pseudopod protrusion and changes in biomechanical properties. J Appl Physiol. 2005 May 1; 98(5):1930-9.
40. A. Bos M, van Vliet T. Interfacial rheological properties of adsorbed protein layers and surfactants: A review. Adv Colloid Interface Sci. 2001 Jul. 27; 91(3):437-71.
41. Norde W, Lyklema J. Thermodynamics of protein adsorption. theory with special reference to the adsorption of human plasma albumin and bovine pancreas ribonuclease at polystyrene surfaces. J Colloid Interface Sci. 1979 9; 71(2):350-66.
42. Lee S, Vörös J. An aqueous-based surface modification of poly(dimethylsiloxane) with poly(ethylene glycol) to prevent biofouling. Langmuir. 2005 Dec. 1; 21(25):11957-62.
43. Andrade J, Hlady V. Protein adsorption and materials biocompatibility: A tutorial review and suggested hypotheses. Biopolymers/Non-Exclusion HPLC. 1986:1-63.
44. Cancer [homepage on the Internet]. 2009 Feb. 10. Available from: http://www.who.int/mediacenter/factsheets/fs297/en/index.html.
45. Weiss L, Dimitrov D. A fluid mechanical analysis of the velocity, adhesion, and destruction of cancer cells in capillaries during metastasis. Cell Biochem Biophys. 1984 Mar. 1; 6(1):9-22.
46. McCusker J, Dawson M T, Noone D, Gannon F, Smith T. Improved method for direct PCR amplification from whole blood. Nucleic Acids Res. 1992; 20:6747.
47. Carlson R H, Gabel C V, Chan S , Austin R H, Brody J P, Winkelman J W. Self-sorting of white blood cells in a lattice. Phys Rev Lett. 1997 Sep. 15; 79(11):2149.
48. Wilding P, Kricka L J, Cheng J, Hvichia G, Shoffner M A, Fortina P. Integrated cell isolation and polymerase chain reaction analysis using silicon microfilter chambers. Anal Biochem. 1998 Mar. 15; 257(2):95-100.
49. Kricka U, Wilding P. Microchip PCR. Analytical & Bioanalytical Chemistry. 2003 11; 377(5):820-5.
50. Sethu P, Sin A, Toner M. Microfluidic diffusive filter for apheresis (leukapheresis). Lab Chip. 2006; 6(1):83-9.
51. Seal S H. A sieve for the isolation of cancer cells and other large cells from the blood. Cancer. 1964; 17(5):637-42.
52. Vona G, Sabile A, Louha M, Sitruk V, Romana S, Schutze K, et al. Isolation by size of epithelial tumor cells : A new method for the immunomorphological and MolecularCharacterization of circulating tumor cells. Am J Pathol. 2000 Jan. 1; 156(1):57-63.
53. Mohamed H, McCurdy L D, Szarowski D H, Duva S, Turner J N, Caggana M. Development of a rare cell fractionation device: Application for cancer detection. NanoBioscience, IEEE Transactions on. 2004; 3(4):251-6.
54. Tan S, Yobas L, Lee G, Ong C, Lim C. Microdevice for the isolation and enumeration of cancer cells from blood. Biomed Microdevices. 2009 Aug. 1; 11(4):883-92.
55. Anderson J R, Chiu D T, Jackman R J, Cherniayskaya O, McDonald J C, Wu H, et al. Fabrication of topologically complex three-dimensional microfluidic systems in PDMS by rapid prototyping. Anal Chem. 2000 Jul. 1; 72(14):3158-64.
56. Cao X, Eisenthal R, Hubble J. Detachment strategies for affinity-adsorbed cells. Enzyme Microb Technol. 2002 Jul. 1; 31(1-2):153-60.
57. Cozens-Roberts C, Lauffenburger D A, Quinn J A. Receptor-mediated cell attachment and detachment kinetics. I. probabilistic model and analysis. Biophys J. 1990 10; 58(4):841-56.
58. Dainiak M, Galaev I, Kumar A, Plieva F, Mattiasson B. Chromatography of living cells using supermacroporous hydrogels, cryogels. Adv Biochem Eng /Biotechnol. 2007 (106):101-27.
59. Ettre L S. Nomenclature for chromatography. Pure & Appl Chem. 1993; 65(4):819-72.
60. Studer V, Hang G, Pandolfi A, Ortiz M, Anderson W F, Quake S R. Scaling properties of a low-actuation pressure microfluidic valve. J Appl Phys. 2004 Jan. 1; 95(1):393-8.
61. Hui A Y N, Wang G, Lin B, Chan W. Microwave plasma treatment of polymer surface for irreversible sealing of microfluidic devices. Lab Chip. 2005; 5(10):1173.
62. Bollinger A, Butti P, Barras J-, Trachsler H, Siegenthaler W. Red blood cell velocity in nailfold capillaries of man measured by a television microscopy technique. Microvasc Res. 1974 1; 7(1):61-72.
63. Butti P, Intaglietta M, Reimann H, Holliger C, Bollinger A, Anliker M. Capillary red blood cell velocity measurements in human nailfold by videodensitometric method. Microvasc Res. 1975 9; 10(2):220-7.
64. Bazargan V. Micro flow control using thermally responsive polymer solutions. 2008:1-152.
65. Desai S P, Freeman D M, Voldman J. Plastic masters—rigid templates for soft lithography. Lab Chip. 2009 (9):1631-7.
66. Duffy D C, McDonald J C, Schueller O J A, Whitesides G M. Rapid prototyping of microfluidic systems in poly(dimethylsiloxane). Anal Chem. 1998 Dec. 1; 70(23):4974-84.

All citations are herein incorporated by reference.

1. A particle separation microstructure comprising:
a body; and
a flow channel extending through the body having an inlet and an outlet for receiving a flow of particles therethrough;
the flow channel comprising:
opposing first and second walls disposed in a spaced-apart relationship; and
at least one protrusion extending from the first wall into the flow channel and extending along a length of the flow channel;
wherein at least a portion of one of the first and second wall is reversibly actuatable between a first and a second position and the first and second walls are substantially parallel in the second position,
in the first position the flow channel is open for receiving the flow of particles,
in the second position the at least one protrusion abuts the second wall and the flow channel is constricted for separating particles from the flow of particles.

2. The microstructure according to claim 1, wherein the reversibly actuatable walls is a flexible membrane actuated by the application of pressure.

3. The microstructure according to claim 1, further comprising a control channel extending through the body having an opening for receiving a pressurizable fluid, the control channel comprising at least a portion of the actuatable first or second wall and a third wall disposed in an opposing spaced-apart relationship, wherein the control channel applies pressure to the portion of the actuatable first or second wall when the flow channel is in the second position.

4. The microstructure according to claim 3 further comprising a plurality of control channels, wherein each of the plurality of control channels independently modulates a portion of the flow channel between the open and constricted positions.

5. The microstructure according to claim 4, wherein each of the plurality of control channels sequentially modulates the portion of the flow channel between the open and constricted positions.

6. The microstructure according to claim 1 further comprising a plurality of flow channels extending through the body, where the flow channels are adjacent to one another.

7. The microstructure according to claim 1, wherein the actuatable first or second wall comprises a flexible material.

8. The microstructure according to claim 1, wherein the flow channel further comprises at least one recess formed in one of the first and second walls for separating particles from the flow of particles when the flow channel is in the second position.

9. The microstructure according to claim 1 further comprising at least two ribs transversely disposed and extending from the at least one protrusion into the flow channel to form at least one recess within the flow channel for separating particles from the flow of particles when the flow channel is in the second position.

10. The microstructure according to claim 9, wherein an angle of the at least two ribs is between about 30° to about 90° relative to a longitudinal axis of the flow channel.

11. The microstructure according to claim 1, wherein the at least a portion of one of the first and second walls is reversibly actuatable in response to a signal.

12. The microstructure according to claim 1, wherein one protrusion extends substantially along the centerline of the flow channel.

13. The microstructure according to claim 1, wherein one protrusion extends substantially along the centerline of the flow channel and one protrusion extends substantially along each edge of the flow channel.

14. The microstructure according to claim 1, wherein the particles are suspended in a fluid.

15. The microstructure according to claim 1, wherein the particles are beads, cells, minerals, particulate, microorganisms or combinations thereof.

16. The microstructure according to claim 15, wherein the cells are eukaryotic cells.

17. The microstructure according to claim 1, wherein at least one of the particles within the flow of particles is labelled.

18. An apparatus for particle separation comprising, the microstructure of claim 1,
a sample conduit and a buffer conduit, connected to the flow channel inlet;
a first particle conduit and a second particle conduit, connected to the flow channel outlet;
flow control valves
disposed between each of the sample and buffer conduits and the flow channel inlet for modulating the flow of particles and a flow of buffer received by the flow channel, and
disposed between the outlet of the flow channel and each of first and second particle conduits for discharging separated particles from the flow of particles, wherein opening and closing of the flow control valves corresponds with actuation of the flow channel between the first and second positions to separate particles from the flow of particles.

19. The apparatus according to claim 18, wherein a plurality of particle separation apparatus are connected in series for serial purification of the separated particles from the flow of particles.

20. A method for particle separation comprising providing a flow of particles to a microstructure comprising a flow channel, the flow channel having a pair of reversibly actuatable opposing inner channel surfaces;
modulating at least a portion of the flow channel inner surfaces between a first and a second position, where the pair of opposing inner flow channel surfaces are substantially parallel in the second position; and
separating particles from the flow of particles, wherein movement of the separated particles is impeded when the flow channel is constricted in the second position, and the flow of particles passes through the flow channel when the flow channel constricted and when the flow channel is open in the first position.

21. The method according to claim 20, the flow channel further comprising a plurality of flow control valves for modulating the flow of particles through the flow channel, wherein opening and closing of the flow control valves corresponds with actuation of the flow channel between the first and second positions to separate particles from the flow of particles.

22. The method according to claim 20 further comprising: providing a flow of buffer, when one of the flow control valves retains the flow of particles at a flow channel inlet for removing particles from the flow channel.

23. A method for selectively attenuating the velocities of specific particle types comprising:
providing a flow of particles to a microstructure comprising a flow channel, the flow channel having a pair of reversibly actuatable opposing inner channel surfaces;
modulating at least a portion of the flow channel inner surfaces between a first position where the flow channel is open, and a second position where the flow channel is restricted, where the pair of opposing inner flow channel surfaces are substantially parallel in the second position, and where the flow of a first population of particles is impeded when flow channel is in the restricted position; and
attenuating the velocity of the first and second population of particles, wherein the first population of particles travels at a slower speed than a second population of particles that passes through the flow channel in the restricted position, and wherein repeated movement of the pair of opposing flow channel surfaces between the first and second positions, concentrates the first population of particles relative to the second population of particles as the flow of particles passes through the flow channel.

24. The method according to claim 23 further comprising modulating a plurality of flow channel portions, wherein each of the flow channel portions moves independently between the first and second positions and the total volume of the flow channel is constant.
